(19) United States
(12) Patent Application Publication
(10) Pub. No.: US 2005/0274058 A1
(43) Pub. Date: Dec. 15, 2005

(54) Insect trap with removable glueboard

(76) Inventor: Daniel James Miller, Knaresborough (GB)

Correspondence Address: Arthur G. Schaier;Carmody & Torrance LLP, 50 Leavenworth Street, P.O. Box 1110, Waterbury, CT, 06721-1110, US

(21) Appl. No.: 10/923,637

(22) Filed: Aug. 20, 2004

(30) Foreign Application Priority Data
Jun. 14, 2004 (GB) 0413218.9

(51) Int. Cl. A01M 1/14

(52) U.S. Cl. 43/114

(57) ABSTRACT

A method of removing a panel from a housing, wherein the panel has a first side to which insects adhere and the housing comprises a first opening through which the panel is removable from the housing, wherein the method comprises the steps of removing the panel from the housing through the first opening by causing a first portion of the panel to collapse towards a second portion of the panel as the panel is being removed from the housing through the first opening; wherein the insects adhering to the first side of the panel are intermediate the first and second portions of the panel as the panel is being removed from the housing through the first opening. An improved insect trap and panel to be used therewith is also provided.

### BACKGROUND OF THE INVENTION

This invention relates generally to insect traps, and in particular, to an insect trap with a removable panel to which insects adhere, wherein the methodology of removing the panel from the housing of the trap, and the construction of the housing and panel to permit such removal, significantly reduces the likelihood of undesirable visible and/or physical contact with the insects adhered thereto. In this way, a hygienic disposal of the panel after its effectiveness has been eviscerated is facilitated.

Insect traps are well known and the subject of much literature and patents. Generally speaking, and to which the present invention pertains, the general state of the art is believed to be that of removable glueboards which slide out of or are otherwise picked up out of an insect trap housing. Regardless of the specific method of removal, the prior art is deficient in its inability to provide for sufficient hygienic removal. That is, in the prior art, there is no arrangement so as to ensure sufficient containment of the insects for effective disposal of the glueboard, or sufficient assurances that the user will avoid physical contact with the adhesive surface or insects trapped thereon. Also, it is believed that the state of the art provides for less than desirable visual and physical removal of the glueboard. Still further, the prior art provides for less than adequate assurances that the glueboard will not stick to the sides of a trashbin after it has been discarded since the adhesive surface may still be viewable or “contactable,” thus leading to the possibility that the glueboard will not advance its way into the trash bag/bin/container after tossed therein, which may lead to undesirable physical contact with the board in the trash bag/bin/container. Accordingly, it is believed that further advancements in the art are desirable. For example, it would be desirable to reduce the risk of physical contact with the adhesive surface and/or the insects adhering to the glueboard upon removal thereof. It would likewise be desirable to reduce the risk of visual contact with the insects adhering to the glueboard.

Still further, it would be desirable to reduce the risk that insects fall or drop off of the glueboard while being discarded in connection with the disposal of the spent glueboard.

Moreover, it would be desirable to provide a more reliable discarding methodology for the glueboard, e.g. to ensure it fully advances into the disposal after discarding.

The present invention overcomes the perceived deficiencies in the prior art as well as provides the objectives and advantages set forth above and below.

### SUMMARY AND OBJECTIVE OF THE INVENTION

Therefore, it is an object and advantage of the present invention to provide an improved insect trap that overcomes the perceived deficiencies in the prior art.

It is a further object and advantage of the present invention to provide an improved method of removing a glueboard from an insect trap housing.

It is a further object and advantage of the present invention to provide an improved glueboard to be used in combination with the improved insect trap and methodology set forth herein.

It is further objects of the present invention to provide an improved insect trap and method of removing the glueboard that reduces the likelihood of physical contact with the adhesive surface and/or the insects trapped thereon, thereby providing a more hygenic method of glueboard removal.

Still further, is it an object of the present invention to provide for a more reliable discarding of the glueboard after use, which more reliably ensures that the glueboard advances its way into the trash bag/bin/container after being tossed therein.

Further objects and advantages of this invention will become more apparent from a consideration of the drawings and ensuing description.

The invention accordingly comprises the features of construction, combination of elements and arrangement of parts and sequence of steps that will be exemplified in the disclosure hereinafter set forth, and the scope of the invention will be indicated in the claims.

To overcome the perceived deficiencies in the prior art and to achieve the objects and advantages above and below, the present invention is, generally speaking, directed to a method of removing a panel from a insect trap housing, wherein the panel has a first side to which insects adhere and the housing comprises a first opening through which the panel is removable from the housing. In a preferred embodiment, the method comprises the steps of removing the panel from the housing through the first opening by causing a first portion of the panel to collapse towards a second portion of the panel as the panel is being removed from the housing through the first opening; wherein the insects adhering to the first side of the panel are intermediate the first and second portions of the panel as the panel is being removed from the housing through the first opening.

Specific steps may also be provided. For example, the step of removing the panel from the housing through the first opening is preferably achieved by pulling the panel out through the first opening, and, the panel may comprise one or more holes through which one or more fingers are inserted for pulling of the panel out through the first opening. In an alternate embodiment, the panel may comprise a pull-tab that is accessible through the first opening, and wherein the method comprises the step of pulling the panel out through the first opening by pulling the pull-tab.

An improved insect trap is also provided, and in a preferred embodiment, comprises a panel having a first side to which insects adhere; a housing dimensioned to receive the panel, wherein the housing comprises a first opening through which the panel is removable from the housing, wherein the first opening is dimensioned so that a first portion of the panel will collapse towards a second portion of the panel as the panel is removed from the housing through the first opening; and wherein any insects adhering to the first side of the panel will be intermediate the first and second portions of the panel on the first side as the panel is being removed from the housing through the first opening. Again, specific features may include holes in, or a pull-tab coupled to, the panel for pulling of the panel out through the first opening.

Lastly, an improved panel is provided. In a preferred embodiment, the panel comprises a first side to which insects adhere; and means by which the panel can be pulled through the first opening; wherein insects adhering to the first side of the panel will be intermediate the first and second portions of the panel as the panel is being removed from the housing. A specific advantageous feature that the panel may include is a predefined edge about which the first and second portions collapse towards each other, whereby the collapsing of the first portion towards the second portion about the predefined edge is facilitated by the predefined edge.

The present invention is widely applicable to a range of applications and may be used in a wide range of areas of interest, such as, by example and not limitation, homes, hospitals, offices, food processing and packaging facilities, restaurants, restrooms and eating areas, just to name a few.

### BRIEF DESCRIPTION OF THE DRAWINGS

The above set forth and other features of the invention are made more apparent in the ensuing Description of the Preferred Embodiments when read in conjunction with the attached Drawings, wherein:

FIG. 1 is a perspective view showing a first embodiment of a panel constructed in accordance with the present invention and a preferred construction of an insect trap housing constructed in accordance with the present invention;

FIG. 2 is a perspective view showing the panel and insect trap housing of FIG. 1 after insertion of the panel into the housing, and just prior to the beginning of a preferred removal process in accordance with a preferred methodology;

FIG. 3 is a perspective view showing the panel of FIG. 1 in a removal sequence in accordance with the present invention;

FIG. 4 is an enlargement of a portion of the illustration in FIG. 3;

FIG. 5 is a perspective view showing an alternative embodiment of a panel constructed in accordance with the present invention along with the insect trap housing constructed in accordance with that illustrated in FIG. 1, along with illustrating the sequence of removal steps in accordance with a preferred methodology of the present. invention;

FIG. 6 shows the insect trap from the view taken about lines 6-6 in FIG. 2, and shows the panel in position through a partial cutaway in the housing; and

FIG. 7 shows a cross-section view of the housing wall and the panel as it is being removed from the opening.

Identical reference numerals in the figures are intended to indicate like parts, although not every feature in every figure may be called out with a reference numeral.

### DESCRIPTION OF THE PREFERRED EMBODIMENTS

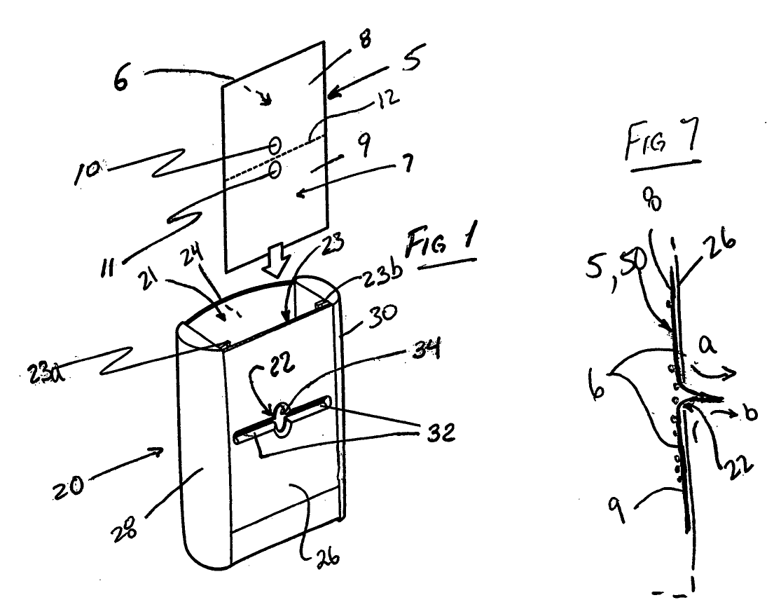

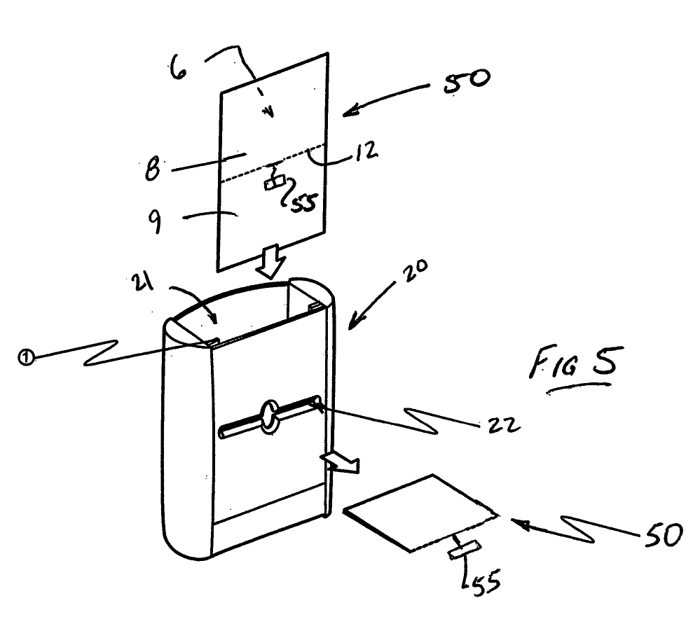

Reference is first made to FIGS. 1-7, which together illustrate an insect trap housing and two preferred constructions of a panel (to which insects will adhere) used in connection therewith, along with a sequence of steps in accordance with preferred methods of removing the panel from the insect trap housing. To ensure the full breath of protection as well as to eliminate any ambiguities, a few terms are defined herein. Firstly, instead of referring to a “glueboard,” an “adhesive board” or any other specific type of board, reference herein shall be made generically to a “panel” to which insects can, will and do adhere. By this definition, it is intended that all types of operable boards, whether glue-covered or adhesive-covered (or any other adequate covering), is covered by the disclosure and claims as drafted. Secondly, it is intended that the “insect trap” be deemed to comprise both the insect trap housing, generally shown in FIG. 1 by reference number 20, and a panel such as that shown generally at 5 (FIG. 1) or 50 (FIG. 5). “Imobilization means” may also be used to mean glue, adhesive or other material for immobilizing the insects on the panel.

Turning now to the particulars of the invention, reference is first made to FIG. 1, which illustrates the aforementioned insect trap housing 20 and panel 5, constructed in accordance with a first embodiment of the present invention.

Panel 5 preferably has a first side 6 to which insects adhere. (i.e. first side 6 has the “immobilization means”). As such, and by way of example, panel 5 can be a glueboard, adhesive board or any other type of board/panel that achieves the function and advantages set forth herein. The second side of panel 5, shown generally at 7, is preferably a non-stick surface. Panel 5 preferably has a perforated, scored or “prefolded” (or other type of predefined) edge 12, which is shown to divide panel 5 into two portions, and essentially equal portions is preferred for obvious reasons, although this is clearly by way of example, since the location of edge 12 may be dictated by the dimensions of housing 20 and/or by the location of the opening to be discussed in greater detail below. If first side 6 has a surface that is completely sticky, then having edge 12 at least essentially bisect panel 5 is preferred so that insects at one edge or the other do not stick out when panel 5 is folded and/or discarded, as disclosed below. For clarity, it should be understood that the term “predefined” as used herein is intended to generically (and generally) cover the many ways of providing such an edge, e.g. by perforation, scoring, prefolding, or otherwise, which may facilitate the collapsing of the portions as disclosed herein.

Before further disclosing particulars of panel 5, reference is briefly made to the construction of housing 20 so that the further particulars of panel 5 are fully appreciated. In accordance with an important aspect of the present invention, housing 20 comprises a first opening, generally indicated at 22, through which panel 5 is removable. Although presumably obvious from the figures, but for completeness, it can be seen that housing 20 comprises a front wall 24, a rear wall 26, a right side wall 28 and a left side wall 30. Adhesives or other coupling means, such as glue, screws, and friction fit or otherwise can be used to form housing 20 from the respective walls. Also “front,” “right,” “left” and “rear” is only used for convenience and not limitation.

As illustrated best in FIGS. 1-3, 5 and 7, opening 22 is dimensioned so that a first portion 8 of panel will collapse towards a second portion 9 of panel 5 as panel 5 is removed from housing 20 through opening 22 (in directions “a” and “b” in FIG. 7). That is, in accordance with disclosing the preferred methodology, panel 5 can be seen as being comprised of two (2) portions, namely portions 8, 9. To be sure, portions 8, 9 need not be (but preferably are) identical in size, for the reasons set forth above. As should now be clearer, edge 12 whether perforated or otherwise, provides the edge about which first and second portions 8, 9 collapses towards each other, whereby the collapsing of the first portion towards the second portion about the predefined edge is facilitated. To be sure, predefined edge 12 is not required but is preferred.

To this end, opening 22 preferably has a slotted region 32 and an elongated region 34. Slotted region 32 guides panel 5 out thereof in a collapsed (e.g. folded) arrangement, while elongated region 34 permits the grasping of panel 5, which will now be disclosed.

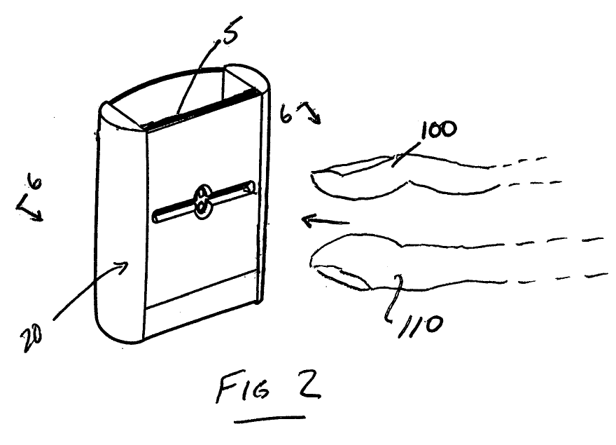

Specifically, in the preferred constructions, panel 5 will either comprise finger holes or a pull-tab, for grasping and pulling in the manner to be now set forth. In the embodiment of FIGS. 1-4, panel 5 comprises at least a first hole 10 that is accessible through first opening 22, wherein the first hole is dimensioned to receive at least a first finger such as a forefinger 100 or thumb 110 (if the hand is inverted) (see FIG. 2). Preferably the panel of this construction will also comprise a second hole 11 that is also accessible through opening 22, and is dimensioned to receive a finger different from the first finger (e.g. the other of the two fingers (e.g. the thumb or the forefinger).

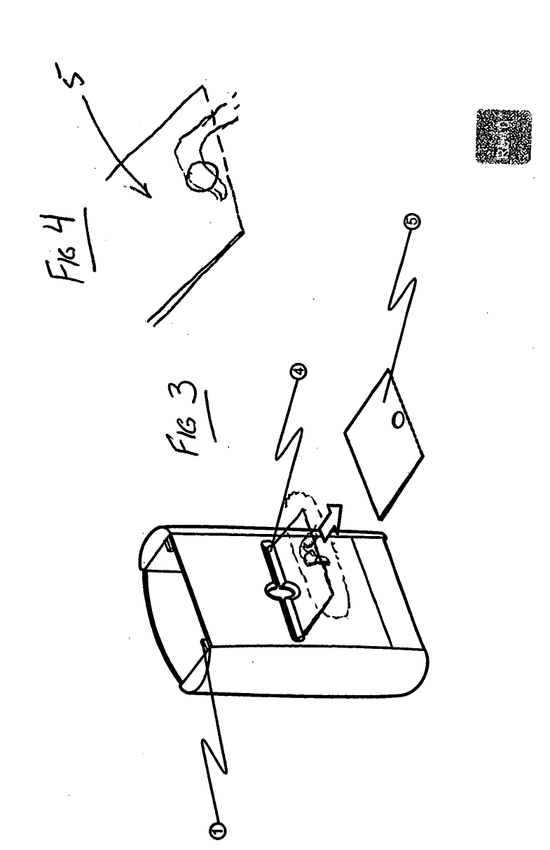

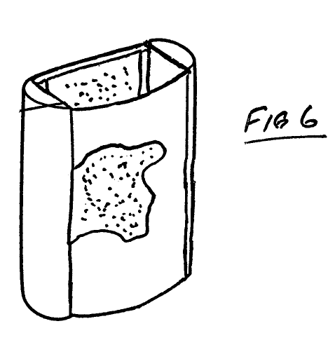

In this way, when it is desired or necessary to remove panel 5 from housing 20, a user merely approaches housing 20 as illustrated in FIG. 2, grasps the respective holes 10 and 11 with the respective digits and begins to pull panel 5 through opening 22, as illustrated in FIG. 3. In this way, panel 5 is removed from housing 20 by the pulling of panel 5 out through opening 22 by the pulling force exerted on panel 5 by the one or more fingers 100, 110 in respective holes 10, 11. Alternatively, as the first and second portions 8 and 9 fold/collapse towards one another, there may not be any reason (or ability) to maintain both fingers aligned in the respective holes, such that only one finger may go through both holes, as illustrated in FIG. 3 and more clearly in FIG. 4. In this case, it is preferable that the holes 10, 11 are at least essentially if not identically dimensioned. Continuous pulling of panel 5 will result in its full removal from housing 20. In this way, and as illustrated in FIG. 3, any insects adhering to first side 6 of panel 5 (see FIG. 6) will be intermediate first and second portions 8, 9 of panel 5 as the panel is being removed from the housing through opening 22.

Thereafter, through compression by one's hand or using adhesive strips at the edges of first side 6 (not shown), the compressed (e.g. collapsed or folded) panel 5 is preferably maintained in its compressed position until discarded.

Reference is briefly made to FIG. 5, which illustrates an alternative embodiment of the panel. In this embodiment, panel 50 comprises a pull-tab 55 that is accessible through (and preferably aligned with) opening 22. In this embodiment, panel 55 is removable out through opening 22 by pulling pull-tab 55. In all other respects, panel 55 is identical to panel 5 (e.g. upon the grasping and pulling of pull-tab 55, panel 50 is removed from housing 20 by the pulling of panel 50 out through opening 22 by the pulling force exerted on pull-tab 55 which may be facilitated by a similarly formed predefined edge 12, perforated or otherwise). Here again, as the first and second portions 8 and 9 compress/collapse towards one another (again, see FIG. 7 as illustrative), any insects adhering to first side 6 of panel 50 will be intermediate first and second portions 8, 9 of panel 50 as the panel is being removed from the housing through the first opening.

In each of the aforementioned embodiments, preferably both the first and second portions on the first side of the panel comprise an adhesive layer (glue or otherwise) to which the insects adhere, and wherein the removal of panel 5, 50 from housing 20 through opening 22 by causing the first portion 8 of panel 5, 50 to collapse towards second portion 9 results in the sandwiching of the insects between the first and second portions 8, 9 of first side 6 of the panel.

Again, although obvious to one skilled in the art from the drawings, housing 20 preferably comprises a second opening 21 for receiving panel 5, 50 therein and a slot 23, formed by runners 23a, 23b, for receiving panel 5, 50 when inserted into housing 22 through second opening 21. In this way, panel 5, 50 is positioned in the slot whereby the first side of the panel faces away from the first opening 22 (see FIG. 6).

Although it is believed that the operation of the present invention has been fully disclosed above, the following is set forth for completeness.

Specifically, in the broadest sense, the present invention is also directed to a method of removing from panel 5, 50 from housing 20. In the broadest embodiment, the method comprises the steps of removing the panel from housing through the first opening (e.g. as first illustrated in FIG. 2 as the fingers move towards the panel, and as progressed in FIG. 3 which shows partial removal of panel 5, 50 from housing 20 through opening 22), wherein opening 22 is dimensioned to cause first portion 8 of panel 5, 50 to collapse towards second portion 9 of panel 5 as the panel is being removed from the housing through opening 22, as most clearly illustrated in FIG. 7. In this way, the insects adhering to the first side of the panel are intermediate first and second portions 8, 9 of the panel as the panel is being removed from the housing through the first opening. Clearly, reference to first portion 8 and second portion 9 can be reversed.

In the most preferred method, the step of removing the panel from the housing through opening 22 is achieved by pulling the panel out therehrough, either by inserting fingers through holes 10, 11 or by grasping and pulling pull-tab 55 as set forth above. However, since the novelty of the preferred methodology lies in the removal of the panel through opening 22 and having the two portions that collapse towards each other during the removal, the present claims would cover an embodiment whereby the panel is pulled out by using a particularly configured tool (not shown), which may for example, could be designed to hook onto a latch/loop (not shown) on the backside surface of panel 5, and would likewise cover an embodiment whereby the panel was pushed out of the opening (e.g. such as by a rod (not shown)), although this latter “pushing methodology” is not the preferred method. For example, an aperture could be provided in wall 24 to provide access to panel 5 from the front side 6.

Consistent with the foregoing, where housing 20 comprises a slot 23 for receiving panel 5, 50 when inserted into the housing through second opening 21, the method may comprise the steps of inserting the panel in the housing through opening 21 (FIG. 1), sliding the panel into the slot (FIG. 2), wherein first side 6 of the panel faces away from the opening 22 (FIG. 6).

Other features, not material to the present invention, may also be provided such as a light source (not shown) for attracting the insects into the housing light. In a preferred embodiment, the light source may be an ultraviolet (UV) bulb.

It will thus be seen that the present invention is both patentably different from and a significant improvement over the prior art. Specifically, an insect trap constructed in accordance with the present invention overcomes the perceived deficiencies in the prior art and thus provides an improved method of removing a glueboard from an insect trap housing. For example, the present invention provides an improved insect trap and method of removing the glueboard that reduces the likelihood of physical contact with the adhesive surface and/or the insects trapped thereon, thereby providing a more hygenic method of glueboard removal. Moreover, As should now also be understood, the present invention provides for an improved procedure for discarding of the panel since there is significantly increased reliability that the there will not be any sticking of the panel to the sides of a trashbin/trashbag/container, thus leading to a reduction in the likelihood in the need to physically touch the panel or the insects after discarding.

While the invention has been particularly shown and described with respect to preferred embodiments thereof, it will be understood by those skilled in the art that changes in form and details may be made therein without departing from the scope and spirit of the invention.

1. A method of removing a panel from a housing, wherein the panel has a first side to which insects adhere and the housing comprises a first opening through which the panel is removable from the housing, wherein the method comprises the steps of:
removing the panel from the housing through the first opening by causing a first portion of the panel to collapse towards a second portion of the panel as the panel is being removed from the housing through the first opening;
wherein the insects adhering to the first side of the panel are intermediate the first and second portions of the panel as the panel is being removed from the housing through the first opening.

2. The method as claimed in claim 1, wherein the step of removing the panel from the housing through the first opening is achieved by pulling the panel out through the first opening.

3. The method as claimed in claim 2, wherein the panel comprises at least a first hole that is accessible through the first opening, and wherein the method comprises the steps of:
inserting at least a first finger in the first hole and pulling the panel out through the first opening by the pulling force exerted on the panel by at least the first finger.

4. The method as claimed in claim 3, wherein the panel comprises a second hole that is accessible through the first opening, and wherein the method comprises the steps of:
inserting a finger different from the first finger in the second hole and pulling the panel out through the first opening by the pulling force exerted on the panel by the one or more fingers in the second hole.

5. The method as claimed in claim 4, wherein the finger in either the first or second hole is further inserted through the other of the first and second holes such that one finger is pulling the panel through the first opening.

6. The method as claimed in claim 2, wherein the panel comprises a pull-tab that is accessible through the first opening, and wherein the method comprises the steps of:
pulling the panel out through the first opening by pulling the pull-tab.

7. The method as claimed in claim 1, wherein the housing comprises a second opening for receiving the panel therein, and the method comprises the step of:
inserting the panel in the housing through the second opening.

8. The method as claimed in claim 2, wherein both the first and second portions on the first side of the panel comprise material to which the insects adhere, and wherein the step of removing the panel from the housing through the first opening by causing the first portion of the panel to collapse towards the second portion results in the sandwiching of the insects between the first and second portion of the first side of the panel.

9. The method as claimed in claim 8, wherein the housing comprises a slot for receiving the panel when inserted into the housing through the second opening, wherein the method comprises the step of:
inserting the panel in the housing through the second opening;
sliding the panel into the slot;
wherein the first side of the panel faces away from the first opening.

10. The method as claimed in claim 1, wherein the step of removing the panel from the housing through the first opening is achieved by pushing the panel out through the first opening.

11. An insect trap comprising:
a panel having a first side to which insects adhere;
a housing dimensioned to receive the panel, wherein the housing comprises a first opening through which the panel is removable from the housing, and
wherein the first opening is dimensioned so that a first portion of the panel will collapse towards a second portion of the panel as the panel is removed from the housing through the first opening;
wherein any insects adhering to the first side of the panel will be intermediate the first and second portions of the panel on the first side as the panel is being removed from the housing through the first opening.

12. The insect trap as claimed in claim 11, wherein the panel comprises at least a first hole that is accessible through the first opening, wherein the first hole is dimensioned to receive at least a first finger;
wherein the panel is removable from the housing by the pulling of the panel out through the first opening by the pulling force exerted on the panel by at least the first finger.

13. The insect trap as claimed in claim 12, wherein the panel comprises a second hole that is accessible through the first opening, wherein the second hole is at least dimensioned to receive a finger different from the first finger;
whereby the panel is removable from the housing by the pulling of the panel out through the first opening by at least the pulling force exerted on the panel by the one or more fingers in the second hole.

14. The insect trap as claimed in claim 13, wherein the second hole is dimensioned at least essentially identically to the first hole so that as the panel is being removed from the housing and the first and second holes align, only one finger is needed to pull the panel out through the opening by the first and second holes.

15. The insect trap as claimed in claim 11, wherein the panel comprises a pull-tab that is accessible through the first opening;
whereby the panel is removable out through the first opening by pulling the pull-tab.

16. The insect trap as claimed in claim 11, wherein both the first and second portions on the first side of the panel comprise material to which the insects adhere, and wherein the removal of the panel from the housing through the first opening by causing the first portion of the panel to collapses towards the second portion results in the sandwiching of insects between the first and second portions of the first side of the panel.

17. The insect trap as claimed in claim 16, wherein the housing comprises:
a second opening for receiving the panel therein; and
a slot for receiving the panel when inserted into the housing through the second opening;
wherein the panel is positioned in the slot whereby the first side of the panel faces away from the first opening.

18. A panel for use in an insect trap housing that itself is dimensioned to receive the panel, wherein the housing comprises an opening through which the panel is removable from the housing, and wherein the opening is dimensioned so that a first portion of the panel will collapse towards a second portion of the panel as the panel is removed from the housing through the opening wherein the panel comprises:
a first side to which insects adhere; and
means by which the panel can be pulled through the first opening;
wherein insects adhering to the first side of the panel will be intermediate the first and second portions of the panel as the panel is being removed from the housing.

19. The panel as claimed in claim 18, wherein the means is either a pull-tab or one or more holes through which one or more fingers are insertable.

20. The panel as claimed in claim 18, wherein the panel includes a predefined edge about which the first and second portions collapse towards each other;
whereby the collapsing of the first portion towards the second portion about the predefined edge is facilitated by the predefined edge.

21. The panel as claimed in claim 20, wherein the predefined edge is formed by perforation, scoring or prefolding.
